(19) United States
(12) Patent Application Publication
(10) Pub. No.: US 2014/0207555 A1
(43) Pub. Date: Jul. 24, 2014

(54) CONTENT GATEWAY

(71) Applicant: Eric Vishria, San Carlos, CA (US)

(72) Inventor: Eric Vishria, San Carlos, CA (US)

(21) Appl. No.: 13/745,365

(22) Filed: Jan. 18, 2013

(51) Int. Cl. G06Q 30/02

(52) U.S. Cl. CPC G06Q 30/0231
USPC 705/14.31

(57) ABSTRACT

A content server receives content articles from the content providers and data about the users' browsing pattern from a web browser. The server determines whether a user is eligible to receive a content article based on credit generating activities performed by the user. The server selects content articles for the user based on the user's online activities, and communicates the selected content article to the user if the user is eligible.

### BACKGROUND

1. Field of Disclosure

The disclosure generally relates to the field of providing online content, in particular to providing users with desirable content and compensating content providers for the content.

2. Description of the Related Art

A user may search for desired content that is generally available on paid websites. The user may find previews (e.g., first page of textual content or first few minutes of multimedia content), but not a complete view including all of the content. To gain access to a complete view, a user may be required to subscribe to a paid site or perform undesired time consuming tasks, like taking surveys, which the user would rather not do.

### SUMMARY

The described embodiments enable a method for delivering content to users and compensating content providers for the delivered content. A content gateway server receives content articles (e.g., textual publications and music videos) from the content providers and data about the users' online activities (e.g., searches performed by the user and web pages visited by the user) from a web browser. The gateway server provides these content articles to users through the web browser if the content article has similarities with users' online activities and the users are eligible to receive content. In one embodiment, to determine whether a user is eligible to receive content, the gateway server determines the user's credit balance in an account. A user may earn credits for the user's account based on credit generating activities performed by the user, which may include activities that generate revenue for the administrators, developers, or owners of the gateway server and/or the browser.

Examples of credit generating activities include users performing searches or buying goods or services using the browser that the gateway server uses to provide content articles. When users perform searches using the browser, for example, the searches may be directed by the browser to a particular search engine. In exchange for directing those searches to the engine, the search engine provides the browser's administrator with a monetary amount. Similarly, when users shop on websites using the browser, the websites may provide the browser's administrator with a monetary amount for directing those buyers to the websites. The gateway server credits the users' credit balance for these credit generating activities, and if the user's credit balance is beyond a threshold, the user is eligible to receive content articles.

The gateway server selects content articles for a user based on the user's online activities and communicates the selected content article (e.g., by transmitting the selected content article to the browser for presentation) to the user if the user is eligible. The server also credits the content provider for the selected content article (e.g., by depositing a monetary sum in the content provider's bank account).

In one embodiment, the server also determines if the user has engaged with the content article, which is used to determine whether to debit the user's credit balance. For example, the server determines that the user has engaged with the content article if the user interacted (e.g., by scrolling or selecting objects in the article) with the content article. In this embodiment, the server debits the user's credit balance and credits the content provider if the server determines that the user has engaged with the content article.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF DRAWINGS

FIG. 1 is a block diagram illustrating a computing environment for delivering content to users and compensating content providers for the delivered content, according to one embodiment.

FIG. 2 is a block diagram illustrating a content gateway server, according to one embodiment.

FIG. 3 is a flow diagram illustrating a method for delivering content to users and compensating content providers for the delivered content, according to one embodiment.

### DETAILED DESCRIPTION

The computing environment described herein enables delivering content to users and compensating content providers for the delivered content. The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures and may indicate similar or like functionality.

### Overview

A user may access complete view of content through the browser (of the disclosed system) on user's client in exchange for performing credit generating activities (like performing web searches or buying products online) on the browser, which the user already performs (perhaps using another browser or interface). For example, the browser may provide a user with content's complete view after the user has performed a threshold number of searches using the browser. The content maybe presented in different contexts like content on the user's homepage, as recommendations in a separate window of the browser, and in a reader view window that exclusively displays recommended content.

The recommended content is provided to the browser by a content provider (or a content publisher) through a content gateway server. The content provider registers with content gateway server and provides content (e.g., textual or multimedia content) to the gateway server. The content provider also provides the gateway server with information about the provider's credit account that may be credited when a user consumes the provider's content. The credit account may be the provider's bank account or another account that accepts some form of currency on behalf of the provider. The content gateway server 104 may transfer money or another currency like electronic money (e.g., Bitcoin) in the content provider's account for consumption of provider's content.

The content provider uploads content to content gateway server, or provides the gateway server with a location of the content on a content server and the gateway server retrieves the content from the provided location. In addition to the content, the content provider may provide associated keywords that indicate the subject matter of the content.

The gateway server analyzes the content's associated keywords and recommends the providers' content to users of browser based on the keywords and user's online activities. The gateway server receives user data about a user's online activities and determines user's interests (or topics of interest) based on the activities. The gateway server matches the user's interests with keywords associated with the received content and determines content recommendations for the user.

The gateway server also maintains a credit account for each user of browser that may consume the provider's content. The credit account includes a credit balance for each user calculated based on the user's credit generating activities, i.e., the user's activities that produce revenue for the administrators/owners/developers of the gateway server and/or the browser.

For example, a user accessing a shopping website through the browser to buy products is a credit generating activity. When the user accesses the shopping website through the browser, the browser indicates to the shopping website that the user was directed to the website through the browser (e.g., through a parameter in the user's request for the website). The shopping website provides a payment to the browser's administrators' credit account (e.g., bank account). The user's shopping activity therefore produces revenue for the administrators and is considered a credit generating activity. Similarly, when the user performs searches using a search bar on the browser, the browser directs those searches to a particular search engine, and the search engine provides a payment to the browser's administrator for those directed searches. These searches are therefore also credit generating activities.

The gateway server determines whether a user is eligible to receive content based on the user's credit balance. A user receives credits for performing credit generating activities, and the user's credit balance increases when the user performs these activities. A user is eligible to receive content if the user's credit balance is beyond a threshold. If the user is eligible, the gateway server transmits content recommendations to the user, receives a recommendation selected by the user, and transmits content for the selected recommendation to the browser for presentation to the user. In one embodiment, the transmitted content is presented to the user without any advertisements. After the user consumes the content, i.e. engages with the content for a threshold amount of time (e.g., by reading, viewing or interacting with content for a threshold amount of time), the gateway server decreases the user's credit balance by a predetermined amount and credits the content provider's credit account for the consumed content (e.g., by transferring money into content provider's bank account).

The gateway server does not “charge” the user, i.e. decrease the user's credit balance, for content browsed but not consumed, by the user. A user may look at the content for a few seconds and decide that the presented content is not what the user desired. A user therefore would not engage with the presented content and move away from the presented content (e.g., by closing the browser window or the web page in which the content was presented). The user in this case has not consumed the content and the gateway server does not decrease the user's credit balance or credit the content provider for the skipped content.

To determine whether a user has engaged with presented content, the gateway server tracks the user's interaction with the presented content. The gateway server may track the user's interaction by running scripts in the background of the interface for presenting the content. For example, a script or a piece of code in the web page or the browser presenting the content may track the user's interaction with the presented content (like the user selecting or scrolling through various sections of the presented content) and transmit information about the tracked interaction to the gateway server. The gateway server analyzes the received information to determine whether the user has interacted with the presented content. For example, the gateway server determines that the user has engaged with the content if the user has viewed the content for more than a threshold amount of time. If the user has engaged with the content, the gateway server credits the content provider's account for the content and reduces the user's credit balance.

By providing content to users in exchange for users performing credit generating activities on the browser, the gateway server provides users with quality content and a viewing experience without requiring the users to register with various subscription-based services or to perform undesirable tasks like taking surveys. The users need not search for desired content only to find a page with a couple of lines from the content and a request for subscribing to a fee based service for additional content. Instead, the users are provided with a complete view of the content that includes all of the content's information meant to be presented to the users. This information may include text and/or multimedia objects, but may not include metadata or other data that is typically not presented to the user. For example, a complete view of a published article includes the text and embedded multimedia objects (like images and videos), and the complete view does not include metadata or keywords associated with the published article.

Because the gateway server credits the content provider for consumed content, the gateway server also provides the content providers with a system that enables the providers to present content to users and to receive compensation for content consumed by the users. Because the gateway server compensates the content providers for content actually consumed (instead of merely browsed) by users, the gateway server also provides the content providers with an accurate account for content that is being consumed or rejected by the users. This implicit feedback can be used by content providers to generate content that is more likely to be consumed by the users.

The description about the browser and the content gateway server assigns particular functions to one entity or another. This description and the function assignment are for illustration purposes and do not limit the server or the client to their assigned functions. Upon reading this disclosure, one of ordinary skill in the art will understand that functions described in one embodiment as being performed on the server side can also be performed on the client side in other embodiments if appropriate. Similarly, the client side functions can be performed by the server if appropriate. Additionally, the functionality attributed to a particular component can be performed by different or multiple components operating together, as deemed appropriate by the implementer.

### System Environment

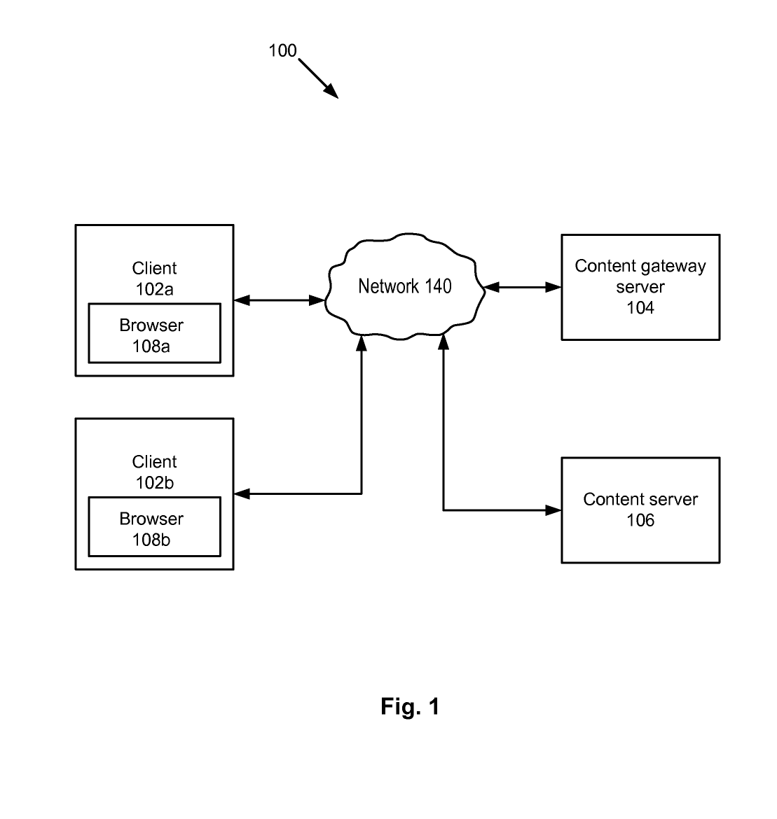

Referring to FIG. 1, the computing environment 100 for delivering content to users and compensating content providers for the delivered content comprises clients 102a-b (collectively referred to as “client 102”) with a browsers 108a-b (collectively referred to as “browser 108”), a content gateway server 104, a content server 106 and a network 140. The client 102 is a computing device with a processor and a memory capable of running applications like browser 108. Examples of client 102 include a desktop, a laptop and a handheld computing device.

The browser 108 is an application for retrieving, communicating, and traversing online data available on various entities like the content gateway server 104 and the content server 106. Additionally, the browser 108 receives from the content gateway server 104 content recommendations for a user of browser 108. The browser 108 communicates the received recommendations to the user.

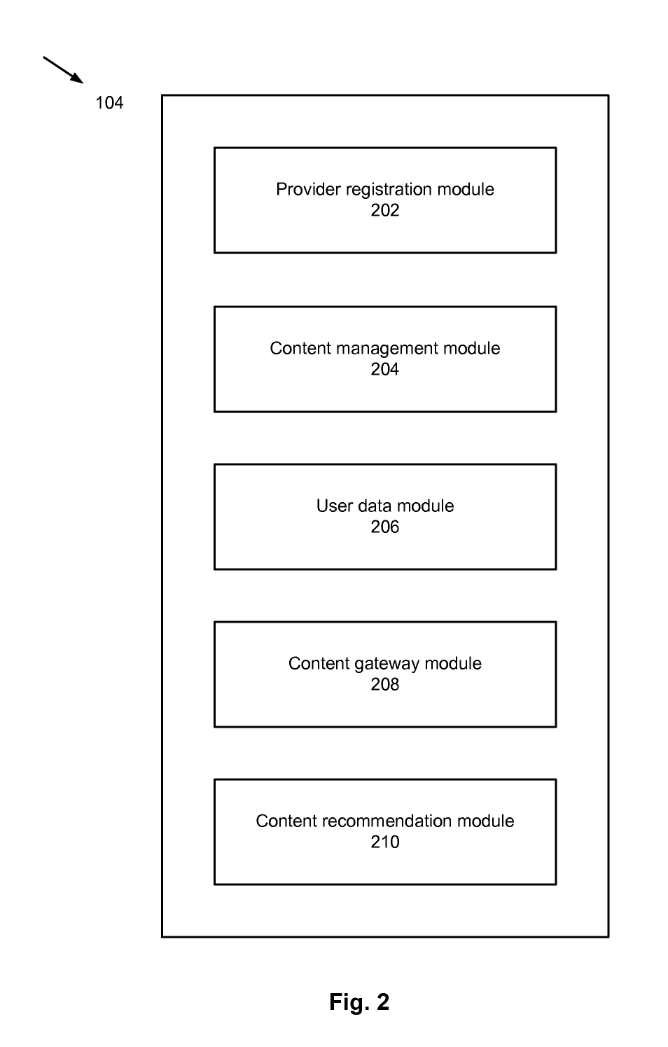

The content gateway server 104 is a computing system with a processor and a memory that determines content recommendations for a user, receives a selected recommendation through browser 108 from the user, determines if the user is eligible for receiving content, and delivers content to the user if the user is eligible. The content gateway server 104 is described in reference to FIG. 2 below.

The content server 106 is a computing device with a processor and a memory that stores online content like web pages, feed content, audio or video streams etc. The content server 106 transmits the stored content over network 140 upon receiving a request for the stored content.

The network 140 represents the communication pathways between the client 102, the content gateway server 104 and the content server 106. In one embodiment, the network 140 is the Internet. The network 140 can also use dedicated or private communication links that are not necessarily part of the Internet.

### Content Gateway Server

FIG. 2 is a block diagram illustrating a content gateway server, according to one embodiment. The content gateway server 104 comprises a provider registration module 202, a content management module 204, a user data module 206, a content gateway module 208, and a content recommendation module 210.

The provider registration module 202 provides the content providers with an interface to register themselves with the gateway server 104. This interface may be used to receive information about the content provider and create a user account for the content provider. Additionally, the interface may be used to receive the provider's credit account that may be credited after determining that a user has engaged with the provider's content. After the provider is registered, the provider may provide content to the gateway server 104.

The content management module 204 receives content from the content provider, receives or determines the keywords or subject matter of the received content, and stores the received content and its associated keywords. The content management module 204 receives the content and its associated keywords through a user interface (not shown). The user interface provides the content provider with a field to provide the location of the content and another field to specify associated keywords. For example, the content provider may provide an article on a particular smartphone, like SAMSUNG GALAXY S III, and provide “SAMSUNG,” “smartphone,” “S III” as keywords for the article.

The field for the associated keywords may be used to specify a file including the keywords or to specify the keywords themselves. For example, the keywords may be included in a text file and the field for the associated keywords may accept as input a location of the text file. In one embodiment, the content management module 204 receives the content and analyzes the content to determine keywords for the content. The content management module 204 may perform natural language processing techniques like topical analysis to determine the associated keywords.

In one embodiment, the content and/or the file including the associated keywords reside on the content server 106 and the content provider provides the content management module 204 with the location(s) of the content and keywords file on the content server 106. After receiving the file location(s), the content management module 204 retrieves and stores the files from their specified locations. In one embodiment, the received content files are indexed by the keywords associated with the content.

The user data module 206 receives data about the user's online activity and determines user's interests based on the received data. In one embodiment, a user indicates the user's interests through an interface on the browser 108 and the browser 108 transmits the indicated interests to the user data module 206. In another embodiment, the user data module 206 receives user data from the browser 108 and determines interests based on the received data, as described in further detail below. For example, the browser 108 receives user specified data (like search terms and uniform resource locators (URLs) from the user) and infers user data based on the user's online activities. The system and method for receiving and transmitting user specified data and inferred user data from a browser to a server are described in U.S. patent application Ser. No. 12/720,394, which is incorporated herein in its entirety.

The browser 108 transmits the user specified data and inferred user data to the user data module 206, and the user data module 206 determines the user's interests based on the received data. For example, in one embodiment, the user data module 206 selects a threshold number of most frequently occurring keywords in the user specified data and/or inferred user data. In another embodiment, the user data module 206 ranks the web pages in the received data based on factors like frequency with which the user visited the web pages, whether the web page is part of the user specified data or inferred user data, and whether the pages in the user data have been recommended by the user's social connections. After ranking the pages, the user data module 206 selects keywords associated with a threshold number of highest ranked pages as the user's interests.

The user data module 206 also stores data about the user's credit generating characteristics and activities. For example, the user data module 206 may receive from browser 108 and store characteristic data indicating the user's geographical location, age group, household income range, and shopping habits/preferences. Additionally, the user data module 206 may receive from browser 108 and store activity data like the number of searches the user performed in a determined amount of time using the browser 108, the amount of time the user spends using the browser 108, and the number of times the user buys goods/services using the browser 108. As described below, these credit generating characteristics and activities are used by content gateway module 208 to determine if the user is eligible to receive content associated with the user's interest. In one embodiment, the user data module 206 encourages the users to increase their credit generating activities on the browser 108 by informing the users about the credit generating activities and their effect on the availability of content to the users. In another embodiment, the user data module 206 encourages the user to perform credit generating activities if the user is currently not available to receive content.

The content gateway module 208 analyzes a user's characteristics and activity data and determines, based on the analysis, if the user is eligible to receive content associated with the user's interests. In one embodiment, the content gateway module 208 determines a credit balance by associating different weights with different activities and characteristics. The weighted activities and characteristics are then combined to determine the credit balance, which is used to determine whether the user is eligible to receive content.

Weighting the activities differently allows the content gateway module 208 to differentiate various user's activities based on value associated with those activities. For example, shopping on a website using the browser 108 may be deemed more valuable than searching using the browser 108 because the shopping activity produces more revenue than searching activity for operators of the browser 108. Similarly, users residing in a particular geographical location may be deemed more valuable because users from the geographical location spend more money on websites than users from other geographical locations.

The content gateway module 208 accounts for values associated with users'activities and characteristics using weights. For example, the content gateway module 208 determines a score based on the number of searches performed by the user and a first weight associated with the searching activity. Similarly, the content gateway module 208 determines a score for the user's geographical location (wherein different locations have different scores) and determines a score associated with the number of times the user bought something through browser 108 based on a second weight associated with the shopping activity. The content gateway module 208 then combines the three scores to determine the user's credit balance. If the credit balance is beyond an eligibility threshold, the content gateway module 208 determines that the user is eligible for receiving content associated with the user's interest. Otherwise, the content gateway module 208 determines that the user needs to increase their credit balance before the user becomes eligible.

If a user is eligible to receive content, content is recommended to the user. The content gateway module 208 determines whether the user has engaged with the recommended content. In one embodiment, the content gateway module 208 determines that the user has engaged with the content based on factors like the amount of time for which the content is displayed to the user, whether the user interacted with the content (e.g., by navigating to the next page or selecting an embedded object within the content), and whether the user forwarded or recommended the content to another user. Information about these factors may be captured and provided to the content gateway module 208 by the browser 108, or by tracking elements such as a script running in the background of the browser 108, when the content is displayed to the user.

After determining that the user has engaged with the recommended content, the content gateway module 208 adjusts (e.g., reduces) the user's credit balance to reflect that the user consumed the recommended content. If the credit balance is adjusted to be below the threshold, the user will need to increase the credit balance to get additional content. Additionally, the content gateway module 208 credits an account associated with the provider of the consumed content to compensate the provider for the consumed content.

The content recommendation module 210 determines content recommendations for a user based on the user's interests and available content. In one embodiment, the content recommendation module 210 determines that a piece of content should be recommended to the user if the user's interests match the subject matter of (or keywords associated with) the content. After determining the content recommendations, the content recommendation module 210 transmits to the browser 108 the recommendations for presentation to the user. In one embodiment, the content recommendation module 210 transmits the content recommendations to the browser 108 only if the user is eligible to receive content. If the user selects one of the presented recommendations, the content recommendation module 210 receives the user's selection from the browser 108, and the recommendation module 210 transmits the selected content to the browser 108 for presentation to the user.

In this manner, the content gateway server 104 beneficially provides the user with content associated with the user's interests and compensates the content provider for the consumed content. Because the content gateway server 104 credits the content provider after determining whether the user has consumed the content, the content gateway server 104 beneficially provides the content provider compensation directly based on the success of the provided content. Such compensation beneficially provides the content provider with valuable feedback regarding the content that is popular with the users and enables the content provider to produce targeted content that is likely to be popular with the users. Additionally, in one embodiment, the system beneficially enables the users to access content without directly paying a monetary sum for the content.

### Content Delivery Methodology

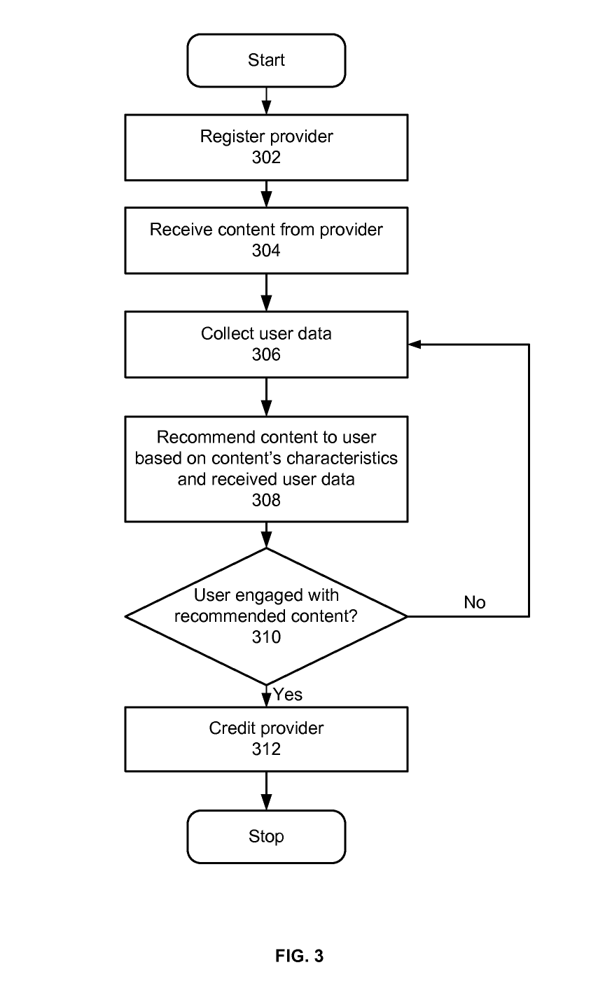

FIG. 3 is a flow diagram illustrating a method for delivering content to users and compensating content providers for the delivered content, according to one embodiment. The content gateway server 104 receives registration information from a content provider and registers 302 the provider. The gateway server 104 then receives 304 content from the provider and receives 306 user data for a user from the browser 108. Based on the received content and the user data, the gateway server 104 recommends 308 content to the user. The gateway server 104 then determines 310 if the user is engaged with the content. If the user is engaged with the content, the gateway server 104 credits 312 the provider's account for the content and repeats steps 306-312. Otherwise, the gateway server 104 repeats steps 306-310.

As mentioned above, the functionality of the browser 108 and the content gateway server 104 has been described for illustration purposes and the above described functionality can be implemented either in the browser 108 or the content gateway server 104. For example, the content gateway server 104 is illustrated above as including the user data module 206 and the content recommendation module 210. In one embodiment, these modules 206, 210 are included in the browser 108. Accordingly, the user data module 206 stores user data in browser 108 and the content recommendation module 208 recommends content to the user based on the stored user data.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method for providing content articles on a web browser to an online user, the method comprising:
receiving information about the user's online activities;
receiving content articles from a content provider that may be displayed to users;
receiving information about one or more credit-generating activities of the user on the web browser other than paying a monetary sum for accessing one or more content articles;
crediting an account of the user based on the one or more credit-generating activities of the user;
determining whether the user is eligible to receive content articles, wherein the determining is based on the account of the user;
selecting, from the received content articles, a content article for the user based at least in part on a similarity between the selected content article and the user's online activities;
communicating the selected content article to a module in the web browser for recommendation to the user if the user is eligible to receive content articles; and
crediting the content provider for the selected content article.

2. The computer-implemented method of claim 1, further comprising:
determining whether the user has engaged with the selected content article; wherein
the provider for the selected content article is credited if the user has engaged with the selected content article.

3. The computer-implemented method of claim 2, wherein determining whether the user has engaged with the selected content article comprises:
determining whether the selected content article has been presented to the user for a threshold amount of time.

4. The computer-implemented method of claim 2, wherein determining whether the user has engaged with the selected content article comprises:
determining whether the user has interacted with the selected content article.

5. The computer-implemented method of claim 1, wherein the one or more credit generating activities include searches performed by the user using the web browser, and determining whether the user is eligible to receive content articles comprises:
determining a credit balance for the user based on a number of searches performed by the user using the web browser; and
determining whether the credit balance is beyond a threshold.

6. The computer-implemented method of claim 1, wherein the one or more credit generating activities include the user buying products or services using the web browser, and determining whether the user is eligible to receive content articles comprises:
determining a credit balance for the user based on products or services bought by the user using the web browser; and
determining whether the credit balance is beyond a threshold.

7. The computer-implemented method of claim 1, wherein determining whether the user is eligible to receive content articles comprises:
determining a credit balance for the user based on an amount of time the user the user spends using the web browser; and
determining whether the credit balance is beyond a threshold.

8. The computer-implemented method of claim 1, wherein the eligibility of the user is further based on a geographical location of the user.

9. The computer-implemented method of claim 1, further comprising:
communicating a message recommending one or more content articles determined to be of potential interest to the user if the user is eligible to receive content articles.

10. The computer-implemented method of claim 1, wherein:
a complete view of the selected article is presented to the user, the complete view including all of the content for the selected article meant for presentation to users.

11. A computer program product for providing content articles on a web browser to an online user, the computer program product comprising a computer-readable storage medium containing computer program code for:
receiving information about the user's online activities;
receiving content articles from a content provider that may be displayed to users;
receiving information about one or more credit-generating activities of the user on the web browser other than paying a monetary sum for accessing one or more content articles;
crediting an account of the user based on the one or more credit-generating activities of the user;
determining whether the user is eligible to receive content articles, wherein the determining is based on the account of the user;
selecting, from the received content articles, a content article for the user based at least in part on a similarity between the selected content article and the user's online activities;
communicating the selected content article to a module in the web browser for recommendation to the user if the user is eligible to receive content articles; and
crediting the content provider for the selected content article.

12. The computer program product of claim 11, further comprising computer program code for:
determining whether the user has engaged with the selected content article; wherein
the provider for the selected content article is credited if the user has engaged with the selected content article.

13. The computer program product of claim 12, wherein determining whether the user has engaged with the selected content article comprises:
determining whether the selected content article has been presented to the user for a threshold amount of time.

14. The computer program product of claim 12, wherein determining whether the user has engaged with the selected content article comprises:
determining whether the user has interacted with the selected content article.

15. The computer program product of claim 11, wherein the one or more credit generating activities include searches performed by the user using the web browser, and determining whether the user is eligible to receive content articles comprises:
determining a credit balance for the user based on a number of searches performed by the user using the web browser; and
determining whether the credit balance is beyond a threshold.

16. The computer program product of claim 11, wherein the one or more credit generating activities include the user buying products or services using the web browser, and determining whether the user is eligible to receive content articles comprises:
determining a credit balance for the user based on products or services bought by the user using the web browser; and
determining whether the credit balance is beyond a threshold.

17. The computer program product of claim 11, wherein determining whether the user is eligible to receive content articles comprises:
determining a credit balance for the user based on an amount of time the user spends using the web browser; and
determining whether the credit balance is beyond a threshold.

18. The computer program product of claim 11, wherein the eligibility of the user is further based on a geographical location of the user.

19. The computer program product of claim 11, further comprising computer program code for:
communicating a message recommending one or more content articles determined to be of potential interest to the user if the user is eligible to receive content articles.

20. The computer program product of claim 11, wherein:
a complete view of the selected article is presented to the user, the complete view including all of the content for the selected article meant for presentation to users.
